(19) United States
(12) Patent Application Publication
(10) Pub. No.: US 2016/0353168 A1
(43) Pub. Date: Dec. 1, 2016

(54) METHODS, APPARATUSES, AND/OR SYSTEMS FOR DISTRIBUTING VIDEO COMPILATIONS OF USER-CAPTURED VIDEOS

(71) Applicant: Tapes, LLC, New York, NY (US)

(72) Inventor: Ari ALLEN, New York, NY (US)

(21) Appl. No.: 14/721,704

(22) Filed: May 26, 2015

(51) Int. Cl. H04N 21/4627; H04N 21/8549; H04N 21/433

(52) U.S. Cl. CPC H04N 21/4627; H04N 21/4334; H04N 21/8549

(57) ABSTRACT

Systems and methods of distributing a video compilation of user-captured videos are presented herein. Users may capture videos via respective user devices and/or upload the user-captured videos to network storage. In certain implementations, requests to generate video compilation may be received. The network storage and/or other video sources may be searched to select one or more videos that satisfy criteria of a given request. A video compilation may be generated based on selected videos. Assignment of one or more permissions of a given video compilation may be transferred between users.

### FIELD OF THE INVENTION

The invention relates generally to distributing video compilations of user-captured videos.

### BACKGROUND OF THE INVENTION

Sharing videos captured on user devices can be a tedious task. Users often navigate through various file folders and/or albums of videos stored on their user device in order to locate a desired video. Video sharing in a peer-to-peer manner may be limited to an amount of available bandwidth of the sending user device and/or receiving user device. However, video files may be too large to send directly to other users via known peer-to-peer messaging platforms, such as SMS and/or other messaging platforms. Users may have to crop videos down to size and/or recapture a video altogether. Some video sharing sites such as YouTube® and/or other sites attempt to solve the problems of conventional peer-to-peer video sharing by providing a central site where videos may be sent to and/or broadcast from. However, playback of videos from these sites requires playback of individual videos one at a time, requiring a user to locate and initiate playback of each video they wish to view. These and other drawbacks exist.

### SUMMARY OF THE INVENTION

The invention addressing these and other drawbacks relates to methods, apparatuses, and/or systems for distributing video compilations of user-captured videos. Users may capture videos via respective user devices. A video may comprise, for example, a video clip that may be relatively short in length and/or other video. For example, a video may be a clip that is a few seconds or minutes long. However, videos may be of other lengths. Users may upload user-captured videos to network storage. Uploads may be routed through a server and/or communicated directly to network storage. A server, network storage, and/or other components may be part of a cloud computing network and/or other type of network.

In an implementation, users may tag information to individual videos and/or video compilation and/or associate information with individual videos and/or video compilation in other ways. For example, users may define metadata tags (e.g., hashtags) and/or other information to associate with a given video and/or video compilation. Other information may include one or more of user information, temporal information, geo-location information, and/or other information.

A video compilation may comprise a series, or “reel”, of multiple user-captured videos that may be played individually and back-to-back. For example, a video compilation may comprise a reel of videos such that, after presenting an end of a first video in the reel, a second video in the reel may automatically begin to play without additional user input. A given video compilation may be configured such that cinematic transitions may be defined between successive videos and/or may cut from one video to the next.

In an implementation, users may generate video compilations based on individual user-captured videos stored at a user device associated with the user (e.g., within local electronic storage of the user device), individual user-captured videos uploaded to the network storage, and/or other videos that may be accessible by a user. For example, users may specify one or more videos to include in a video compilation. A request to generate the video compilation may be generated, and/or the specified videos may be identified as request criteria of the video compilation. In some implementations, other videos that may be accessible by a user may include videos from third-party sources and/or other sources. By way of non-limiting example, a third-party source where videos may be accessed may include a third-party social media platform (e.g., Facebook®, Twitter®, and/or other social media platform), a third-party electronic storage platform (e.g., Dropbox®, iCloud®, and/or other third-party electronic storage platforms), and/or other sources.

In an implementation, a user may submit a request to generate a video compilation based on user-provided tags and/or other user-provided information. The network storage and/or other video sources may be searched to find a plurality of videos that match the user-provided information. One or more select videos from the plurality of videos may be included in the video compilation. A user's ability to access one or more given videos from the network storage and/or other video sources may be based on permissions assigned to the user and/or permissions assigned to individual videos stored in the network storage and/or other video sources. By way of non-limiting example, permissions may correspond to one or more user's ability to preview, playback, and/or modify videos uploaded by other users; public accessibility of videos; and/or other permissions. By way of non-limiting example, videos associated with third-party sources may be restricted by permission established by the third-party sources and/or users of the third-party sources.

In an implementation, assignment of one or more permissions of a given video compilation may be transferable between users. By way of non-limiting example, in an implementation, a user may be a system administrator and/or other user. The administrator may generate a video compilation on behalf of another user. The assigned user may be, for example, a celebrity, a user subscribed to a paid service, and/or other users.

In some implementations, users may modify video compilations. Modifications may include adding (e.g., contributing) videos to a given video compilation and/or other modifications. In some implementations, user devices may be configured such that a predefined user input provided at a user device may generate a request to modify a given video compilation. For example, a user device may display a preview and/or a playback of a given video compilation. A user may provide predefined input during presentation of the playback and/or preview to generate a request to modify the video compilation. In an implementation, the predefined input may include a swipe gesture on a touch-sensitive display screen of the user device and/or other input. Users may contribute to video compilations in other ways.

In some implementations, a user device may be configured to stream, in real-time or near real-time, a live captured video to the server to contribute to a video compilation. The video compilation may be updated in real-time, or near real-time, to include the video as it is recorded and/or streamed from a user device. In some implementations, another user currently viewing the video compilation may be able to view the streaming video in real-time or near real-time as it is added to the video compilation.

These and other features of the present invention, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a”, “an”, and “the” include plural referents unless the context clearly dictates otherwise. In addition, as used in the specification and the claims, the term “or” means “and/or” unless the context clearly dictates otherwise.

### BRIEF DESCRIPTION OF THE DRAWINGS

The invention is illustrated by way of example, and not by way of limitation, in the figures of the accompanying drawing and in which like reference numerals refer to similar elements.

FIG. 1 illustrates a diagram of a system configured for distributing video compilations of user-captured videos, in accordance with one or more implementations.

FIG. 2 illustrates a flow diagram of information exchange between a server used in the system of FIG. 1 and a user device associated with a user of the system, in accordance with one or more implementations.

FIG. 3 illustrates a flow diagram of information exchange between a server used in the system of FIG. 1, a first user device associated with a first user of the system, and a second user device associated with a second user of the system, in accordance with one or more implementations.

FIG. 4 illustrates an exemplary user interface presented on a display of a user device, in accordance with one or more implementations.

FIG. 5 illustrates another exemplary user interface presented on a display of a user device, in accordance with one or more implementations.

FIG. 6 illustrates yet another exemplary user interface presented on a display of a user device, in accordance with one or more implementations.

FIG. 7 illustrates a flow chart of a method of distributing video compilations of user-captured videos, in accordance with one or more implementations.

FIG. 8 illustrates a flow chart of a method of adding user-captured videos to a video compilation of user-captured videos, wherein users capture the videos via respective user devices and upload the user-captured videos to network storage, in accordance with one or more implementations.

FIG. 9 illustrates a flow chart of a method of presenting a video compilation of user-captured videos on a user device, wherein playback of the video compilation includes at least part of a video that is added to the video compilation in real-time or near real-time as it is captured at another user device, in accordance with one or more implementations.

### DETAILED DESCRIPTION OF THE INVENTION

In the following description, for the purposes of explanation, numerous specific details are set forth in order to provide a thorough understanding of the implementations of the invention. It will be appreciated, however, by one skilled in the art that the implementations of the invention may be practiced without these specific details or with an equivalent arrangement. In other instances, well-known structures and devices are shown in block diagram form in order to avoid unnecessarily obscuring the implementations of the invention. It should be noted that features (e.g., components, operations, or other features) described herein may be implemented separately or in combination with one another.

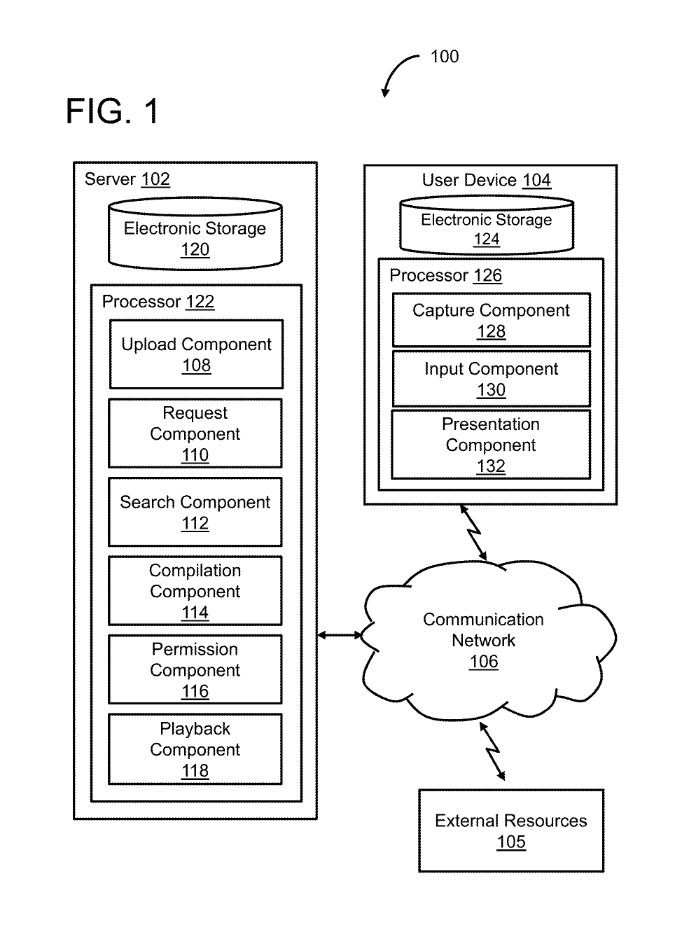

FIG. 1 illustrates a diagram of a system 100 configured for distributing video compilations of user-captured videos, in accordance with one or more implementations. System 100 may comprise one or more servers 102. Server 102 (or servers 102) may be configured to communicate with one or more user devices 104 according to a client/server architecture (e.g., over communication network 106 and/or via other communication medium). Users may access system 100 via user devices 104.

Server 102 may include one or more physical processors 122. Processor 122 (or processors 122) may be programmed to execute machine-readable instructions. The machine-readable instructions may include one or more computer program components which, when execute, facilitate distributing video compilations of user-captured videos and/or other features or functions. The computer program components may include one or more of an upload component 108, a request component 110, a search component 112, a complication component 114, a permission component 116, a playback component 118, and/or other components.

A given user device 104 may include one or more physical processors 126. Processor 126 (and/or processors 126) may be programmed to execute machine-readable instructions. The machine-readable instructions may include one or more computer program components which, when executed, facilitate distributing video compilations of user-captured videos and/or other features or functions. The computer program components may include one or more of a capture component 128, an input component 130, a presentation component 132, and/or other components.

Referring to server 102, in an implementation, the upload component 108 may be configured to receive communications (e.g., uploads) of videos and/or other information associated with videos from user devices (e.g., user device 104). The upload component 108 may be configured to store the received videos and/or other information in network storage. Network storage may comprise one or more of storage included with or coupled to server 102 (e.g., electronic storage 120 and/or other storage) and/or other storage accessible by server 102 (e.g., storage included in an external resource 105, and/or other storage).

In an implementation, a video upload may correspond to a video file stored at, generated by, and/or otherwise accessible to user device 104. By way of non-limiting example, user device 104 may be configured to capture videos and/or store the videos as executable video files in electronic storage 124 of the user device 104. The user device 104 may communicate (e.g., upload) the video files and/or other information to the server 102 (e.g., upload component 108) over communication network 106 and/or other networks. In an implementation, a video upload may correspond to a communication of at least part of a captured video. For example, at least part of a video may be uploaded via communication of a video stream corresponding to the video from the user device 104 to the upload component 108. By way of non-limiting example, user device 104 may be configured to capture a given video and stream the given video in real-time, or near real-time, to the server 102 as the video is being captured.

In an implementation, individual videos and/or video compilations may be associated with information. Information associated with a given video and/or video compilation may include one or more of user-defined information, user information, temporal information, geo-location information, and/or other information.

User-defined information may correspond to descriptive, semantic, contextual, and/or other types of information a user may wish to associate with a given video and/or video compilation. By way of non-limiting example, a user may provide information to associate with a given video and/or video compilation by “tagging,” “labeling,” and/or otherwise associating the video and/or video compilation with the information. In an implementation, tagging may correspond to storing information as metadata of a given video and/or video compilation. By way of non-limiting example, users may associate information with videos by defining hashtags and/or other metadata tags of a video and/or video compilation.

User information may correspond to information about a user of one or more user devices. By way of non-limiting example, user information may include one or more of a name (e.g., username, handle, and/or other information), a picture, server usage information (e.g., relating to amount of video uploads, contributions to video compilations, user associates such as “friends” or “followers,” and/or other usage information), demographic information (e.g., age, gender, place of residence, and/or other information), profile information, and/or other information. In some implementations, user information may include information provided by a user and/or obtained from other sources (e.g., a third-party social media platform, and/or other source).

Temporal information may correspond to a time and/or date associated with a given capture of a given video, a given upload of the given video, and/or other temporal information. By way of non-limiting example, temporal information may be associated with a given video at the time of capture of the given video by a user device used to capture the given video. In an implementation, temporal information may be associated with a given video by time stamping the given video at or around the time of capture and/or by other techniques. In an implementation, temporal information may be associated with a time of upload of a video to the upload component 108.

Geo-location information may correspond to a geo-location of a given user device at or around the time of capture of a given video. By way of non-limiting example, geo-location information may be provided by a geo-location sensor included with or coupled to a user device. A given user device may be configured to associate geo-location information determined from the geo-location sensor with a given video at or around the time of capture of a given video.

In an implementation, information associated with a given video may be received by the upload component 108 concurrently with an upload of the given video, may be determined subsequent to a given upload, and/or by other techniques. By way of non-limiting example, information may be associated with a given video at a user device at or around the time of capture of the given video (e.g., via user input at the user device to define tags and/or other information, output from a geo-location sensor, a time stamp, and/or other techniques). An upload of a given video from a user device to the server 102 may concurrently include a communication of information associated with the given video.

In an implementation, information associated with a given video may be determined subsequent to a given upload. By way of non-limiting example, a user may upload a video and/or other information to the upload component 108. The upload component 108 may be configured to communicate a prompt to a user at a user device for input from the user to define information to be associated with a given uploaded video. By way of non-limiting example, the upload component 108 and/or user device may be configured to effectuate presentation of a user interface on a display of the user device. The user interface may be configured to include one or more of instructions, input fields, interface elements, and/or other components configured to facilitate receiving input from a user to define information to be associated with a given uploaded video.

Referring now to user device 104, the capture component 128 may be configured to obtain and/or store videos captured using an imaging device (not shown) included with or coupled to the user device 104. By way of non-limiting example, an imaging device may include a video camera, a still picture camera, and/or other imaging devices. The capture component 128 may be configured to store videos as video files in storage that may be included with the user device 104 (e.g., electronic storage 124 and/or other storage) and/or otherwise accessible to the user device 104 (e.g., a removably coupled external storage device, and/or other accessible storage). In an implementation, the capture component 128 may be configured to generate video streams based on captured and/or stored videos. In an implementation, a video stream may correspond to a real-time (e.g., “live”), or near real-time, capture of a video by the user device 104. The capture component 128 may be configured to communicate videos and/or video streams to the server 102 over communication network 106 and/or other networks.

A given video compilation may be associated with multiple user-captured videos and/or other information. Playback of a given video compilation may correspond to a seamless playback of the multiple user-captured videos in a predetermined order and/or other playback. By way of non-limiting example, playback of a given video compilation may be initiated based on user input at a user device (e.g., input corresponding to a “play” button, and/or other input). The given video compilation may be associated with a first video, a second video, and/or other videos. A seamless playback of the first video, second video, and/or other videos of the given video compilation may correspond to playing the first video, and transitioning from an end of the first video to a beginning of the second video without additional user input to effectuate the transition. As such, playback of a video compilation may comprise continuous playback of videos associated with the video compilation without additional user input.

Referring now to server 102, in an implementation, the request component 110 may be configured to receive requests of users for one or more of generating video compilations, previewing video compilations, playing back video compilation, modifying video compilations, and/or other requests. In an implementation, a request to generate a video compilation may include one or more request criteria and/or other information. Request criteria may correspond to information associated with individual videos stored in network storage and/or other video sources, one or more user-specified videos, a quantity of videos, a temporal order of videos, and/or other information.

In an implementation, request criteria of a request to generate a video compilation may indicate user-specified videos and/or other information. User-specified videos may include one or more of videos known to the user, captured by the user, stored in a user device associated with the user, uploaded by the user, and/or other videos. Videos may be identifiable by a user by information that may be representative of the video. For example, information representative of a given video may include one or more of a key frame or thumbnail that may be representative of the video, a serial number, a name, a network address, and/or other information used to identify a specific video. By way of non-limiting example, a user interface may display key frames and/or other information representative of one or more videos that may be stored on a user device, uploaded by the user, and/or otherwise accessible by the user. A user may specify one or more videos by selecting, via input on a user device, a key frame of a given video, a name of a given video, serial number of a given video, a network address of a given video, and/or other information. Users may input a desired order of the videos and/or other information.

In an implementation, request criteria may correspond to information associated with individual videos stored in network storage and/or other video sources, and/or other information. By way of non-limiting example, a user interface on a user device may include an input field configured to receive input of one or more hashtags, usernames, time/date, geo-locations, user-specified videos, and/or other information. A user may provide input via a touch-sensitive display of the user device 104, a keyboard, voice input, and/or other input mechanisms. Based on the user input, the user device 104 (e.g., input component 130 and/or other components) may be configured to generate one or more requests. The user device 104 may communicate generated requests to the server 102 (e.g., request component 110).

In an implementation, the input component 130 of user device 104 may be configured to receive user input related to one or more requests of a user. The input component 130 may be configured to communicate requests to the server 102 (e.g., request component 110). By way of non-limiting example, the user device 104 may be configured to effectuate presentation of a user interface on a display of the user device 104. The user interface may include instructions, input fields, interface elements, and/or other components configured to facilitate receiving user input to generate one or more requests.

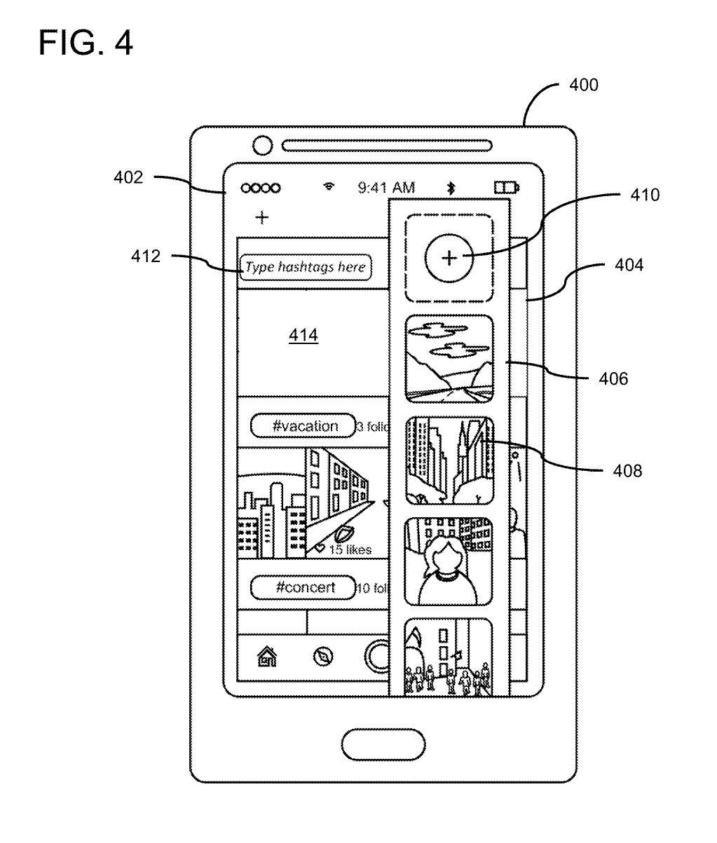

By way of non-limiting illustration in FIG. 4, an exemplary user interface 404 displayed on a display screen 402 of a user device 400 is shown. In an implementation, the display screen 402 may be a touch-sensitive display screen and/or other display screen. The display screen 402 may be configured to receive user input via physical touching, pressing (e.g., tap-and-hold), tapping, swiping, and other physical and/or non-physical input via the display screen 402. The user interface 404 may comprise an exemplary user interface configured to receive user input to generate a request to generate a video compilation, and/or other requests.

In an implementation, the user interface 404 may include a first interface element 406 and/or other components. The first interface element 406 may display key frames 408 of videos selected by a user of which they wish to include in a video compilation. The key frames 408 shown may correspond to videos that may be readily available to the user including one or more of videos stored by the user device 400, uploaded via the user device 400, and/or otherwise accessible to the user of the user device 400. The first interface element 406 may be used to define request criteria including, but not limited to, user-specified videos represented by the various key frames 408. In an implementation, a user may select a second interface element 410 corresponding to adding additional videos to the first interface element 406 thus adding the selected additional videos to the request criteria. By way of non-limiting example, responsive to selection of the second interface element 410 by a user, the user may be presented with a thumbnail view, an album view, a list view, a menu view, a grid view, and/or other views of the videos available to the user for selection. The user may select one or more videos presented as desired for inclusion in a request to generate a video compilation.

In an implementation, the user interface 404 of FIG. 4 may include one or more input fields such as first input field 412 and/or other components. The first input field 412 may be configured to receive input from a user to define information to be associated with the video compilation generated by the current request. For example, a user may input desired hashtags and/or other information into the first input field 412. The user may finalize their selections and/or inputs to generate a request by entering and/or selecting a final “submit” or “send” element (not shown) of the user interface 404. A preview area 414 may also be included in the user interface 404 to allow the user to preview the video compilation.

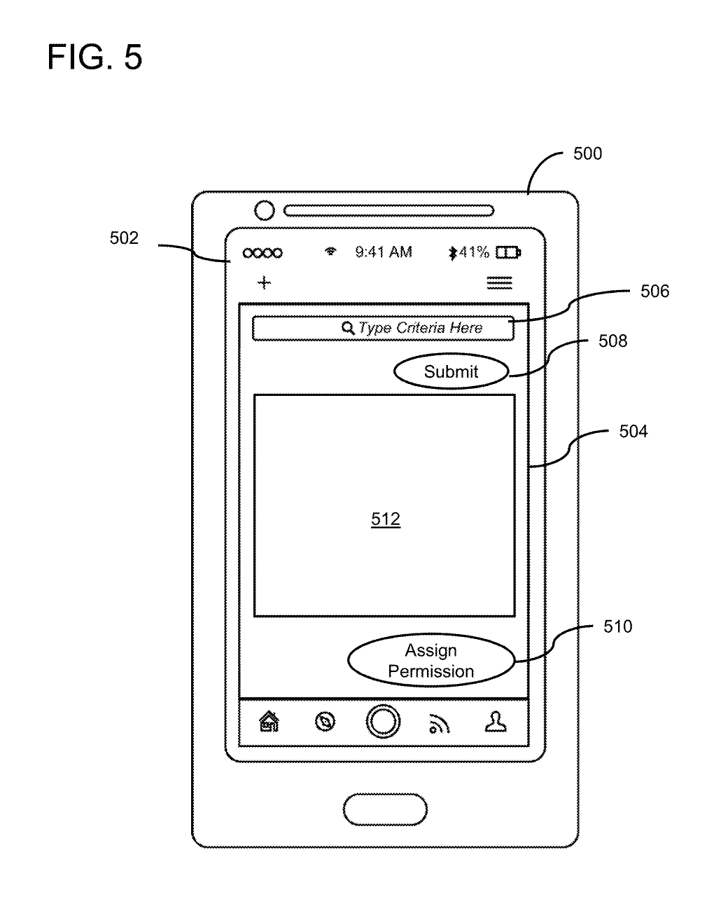

FIG. 5 depicts another exemplary user interface 504 displayed on a display screen 502 of a user device 500 is shown. In an implementation, the display screen 502 may be a touch-sensitive display screen and/or other display screen. The display screen 502 may be configured to receive user input via physical touching, pressing, tapping, swiping, and other input on the display screen 502. The user interface 504 may comprise an exemplary user interface configured to receive user input to generate requests to generate a video compilation, and/or other requests.

In an implementation, the user interface 504 may include one or more of a first input field 506, a first interface element 508, a second interface element 510, a preview area 512, and/or other components. The first input field 506 may be configured to receive user input of information corresponding to one or more request criteria. By way of non-limiting example, a user may enter and/or select information including one or more of user-defined information, user information, temporal information, geo-location information, user-specified videos, and/or other information into the first input field 506 corresponding to one or more videos a user may wish to include in a video compilation. A user may submit and/or finalize the generation of a request by entering and/or selecting the first interface element 508 (e.g., which may correspond to a final “submit” of the entered and/or selected request criteria for sending to the server 102 as request criteria). The user interface 504 may include a preview area 512 for previewing a video compilation.

In an implementation, the user interface 404, user interface 504, and/or other user interfaces may facilitate editing of videos to be included in a video compilation. By way of non-limiting example, a user interface may be configured to include components, features, and/or functions that may enable video editing of one or more videos. Editing may include one or more of trimming a selected video; adding one or more of visual enhancements, audio enhancements, a sound track, and/or other enhancements to a given video; defining cinematic transitions (e.g., between a selected video and a subsequently selected video); and/or other editing features.

Returning to FIG. 1, the search component 112 of server 102 may be configured to search network storage and/or other video sources for a plurality of videos that satisfy one or more request criteria of a received request to generate a video compilation. By way of non-limiting example, a search may be based on determining matches between the one or more request criteria and information associated with one or more videos stored in the network storage and/or other video sources. For example, if a first request includes first request criteria including a first specified hashtag and/or other information, the search component 112 may be configured to search the network storage and/or other video sources for one or more videos that may be associated with the first hashtag and/or other information. In some implementations, other video sources may include electronic storage 124 that may be coupled to user device 104, third-party sources and/or other sources. By way of non-limiting example, a third-party source may include a third-party social media platform (e.g., Facebook®, Twitter®, and/or other social media platform) and/or other sources.

In an implementation, the search component 112 may be configured to select, from the plurality of videos, at least some of the videos for the video compilation. In an implementation, a selection by search component 112 may be based on request criteria (e.g., specifying a particular amount of videos from the plurality of matched videos to include in a video compilation, and/or other information), permissions associated with individual ones of the videos (e.g., whether a matched video is available to a given user, public, and/or otherwise restricted by other permissions), a selection threshold (e.g., a default number of videos set by search component 112 and/or other components to include in the video compilation), and/or other information. In some implementations, if the user has specifically identified videos to include in video compilation, some or all of the videos may be included in the video compilation.

In an implementation, the search component 112 may be configured to search electronic storage 124 of user device 104 for a plurality of videos that satisfy one or more request criteria of a received request to generate a video compilation. In some implementations, the search component 112 may be configured to select and/or suggest selections of at least some of the plurality of videos for the video compilation. Suggestions may be based on information associated with individual ones of the videos stored in electronic storage 124. By way of non-limiting example, one or more videos may be suggested for inclusion in a video compilation over one or more other videos based on time stamps associated with the videos, geo-locations associated with the videos, and/or other information associated with videos. By way of non-limiting example, one or more videos having a time stamp of a first date and/or first date range may be suggested over one or more other videos having a time stamp of a second date and/or second date range. By way of non-limiting example, one or more videos associated with a first geo-location may be suggested over one or more other videos having a time stamp of a second date and/or date range.

The user device 104 may be configured to effectuate presentation of one or more suggested videos on a display of the user device 104. By way of non-limiting example, individual suggested videos may be presented using one or more of a keyframe associated with the video, a description of the video, and/or other presentation techniques. A user may provide entry and/or selection of one or more suggested videos to include in a video compilation.

In an implementation, the compilation component 114 may be configured to generate a given video compilation based on videos selected by the search component 112 and/or the videos specifically identified and/or selected by a user. In an implementation, generating a video compilation may include one or more of appending videos together in succession, storing appended videos as the video compilation in network storage, associated network addresses of videos with the video compilation, and/or other operations.

By way of non-limiting example, the search component 112 may search for and/or select a first video, a second video, and/or other videos based on a first request. The compilation component 114 may be configured such that generating a video compilation includes one or more of obtaining the first video, the second video, and/or other videos from the network storage and/or other video sources; appending the second video to the first video; appending other videos in succession; storing the appended video reel as the video compilation in the network storage; and/or other operations. The video compilation may include the combination of the first video, second video, and/or other videos.

In an implementation, generating a video compilation may include obtaining network addresses of selected videos within network storage, associating the video compilation with the network addresses, and/or other operations. By way of non-limiting example, the search component 112 may search for and/or select a first video, a second video, and/or other videos based on a first request. The compilation component 114 may be configured such that generating a video compilation includes one or more of identifying a first network address of the first video, a second network address of the second video, and/or other network addresses of other videos; associating the video compilation with the first, second, and/or other network addresses; and/or other operations. The generated video compilation may include the network addresses as pointers and/or identifiers of individual videos when playback is requested. In some implementations, if a selected video is from third-party source, a network address of the video may include a network address associated with the third-party source. In some implementations, if a third-party source allows videos to be obtained (e.g., downloaded), the videos may be obtained and stored in network storage and handled the same or similar to other videos within network storage.

In an implementation, the request component 110 may be configured to receive requests of users to preview, playback, modify, and/or otherwise access one or more video compilations, and/or other requests. Modification may include one or more of editing a video compilation, adding videos to a video compilation, removing videos from a video compilation, adding information to associate with a video compilation, removing information associated with a video compilation, and/or other modifications.

In an implementation, user devices may generate requests to preview a video compilation and/or communicate such requests to the request component 110. Requests to preview a video compilation may be generated based on input by a user at a given user device. In an implementation, requests to preview a video compilation may be generated based on user input relating to generating the video compilation (described above), searching for a video compilation, selecting a video compilation, and/or otherwise conveying a request to preview a video compilation. By way of non-limiting example, a user interface presented on a given user device may include a search field and/or other components where a user may provide entry and/or selection of information to search for video compilation (e.g., entering and/or selecting user-defined information, user information, temporal information, specified videos, geo-locations, and/or other information). Based on a request to preview a video compilation, the playback component 118 may be configured to effectuate display of a preview at a user device. For example, the playback component 118 may push information to a user device that may be used by the user device to effectuate display of the preview.

In an implementation, a preview of a video compilation may comprise one or more of a timeline of the video compilation, a video trailer of the video compilation, and/or other previews. A timeline preview may include a select subset of frames of a video compilation displayed statically in a temporal order of the frames, and/or other components. By way of non-limiting example, a timeline preview may include a beginning frame, an ending frame, and/or other frames. Individual frames may include a still image of the video compilation at a point in time corresponding to the temporal position of a given frame in a timespan of the video compilation.

In an implementation, a video trailer may include a select subset of frames of a video compilation. The select subset of frames may include consecutive frames (e.g., appearing “back-to-back” in the video compilation) and/or other frames. A subset of consecutive frames may facilitate video playback of at least a portion of the video compilation corresponding to the subset of consecutive frames.

In an implementation, the search component 112 may be configured such that providing a preview may include one or more of determining frames of a given video compilation, selecting a subset of the frames for the preview, and/or other operations.

In an implementation, frames of a video compilation may be determined based on frames of corresponding videos included in the video compilation. By way of non-limiting example, individual videos may include multiple frames. The video compilation may correspond to a predetermined order of multiple videos. The frames of the video compilation may include the frames of the multiple videos in the order of the videos.

In an implementation, a subset of frames may be selected for a preview (e.g., a timeline preview) based on predetermined intervals and/or other selection techniques. Predetermined intervals may be time-based, video-based, and/or based on other selection techniques. By way of non-limiting example, a predetermined time-based interval may correspond to selecting frames at temporal intervals along the timespan of a video compilation. For example, when selection of frames for a preview is based on temporal intervals, the frames selected for the preview may include a first frame at a first point in time, a second frame at a second point in time, a third frame at a third point in time, and/or other frames at other points in time along the timespan of a given video compilation where the points in time of the selected frames are periodic points along the timespan of the video compilation. In an implementation, the first point in time may correspond to a beginning of the video compilation (e.g., time “zero” and/or other point in time), the second point in time may correspond to a predetermined time interval following the first point in time (e.g., a point of time that corresponds to a predetermined amount of seconds, minutes, and/or hours after the first point in time), the third point in time may correspond to a predetermined time interval following the second point in time, etc. In an implementation, the points in time when frames are selected may be equally spaced, unequally spaced (e.g., random lengths of time between each selection), periodically spaced, and/or spaced apart in other ways. For example, the point in time associated with each selected frame may be the same length of time from the point in time associated with an immediately preceding selected frame and from the point in time associated with an immediately successive selected frame.

When using predetermined time-based intervals, the selection of frames for a preview may be independent of the specific allocation of frames of the video compilation to individual videos included in the video compilation. As such, individual videos of a video compilation may not be readily distinguishable from each other in a preview (e.g., given that frames may not necessarily have been selected for the preview based on the individual videos, but rather based on the timeframe of the video compilation itself). For example, time-based frame selection may result on a different amount of frames being selected from different videos of the video compilation for the preview (e.g., the preview may include X selected frames of a first video of the video compilation, Y selected frames of a second video of the video compilation, etc., where the selected frames correspond to points in time spaced along the time span of the video compilation, and where X and Y are different numbers).

In an implementation, a predetermined video-based interval may correspond to selecting one or more frames based on the individual video constituents of a video compilation. For example, a video compilation may include a first video, second video, and/or other videos. When selection of frames for a preview is based on a predetermined video-based interval, the selected frames may include a predetermined amount of frames specifically from the first video, a predetermined amount of frames specifically from the second video, and/or predetermined amounts of frames specifically from other ones of the other videos of the video compilation (e.g., selecting one or more frames from each video of the video compilation for the preview). Video-based selection may differ from time-based selection since video-based selection may take into account the frames specifically associated with individual videos of the video compilation, while the time-based technique may include selecting frames for a preview based on a timing criteria (e.g., selecting frames corresponding to periodic time intervals of the video compilation as a whole) without regard to which individual videos of the video compilation that the frames are associated.

In an implementation, the input component 130 of user device 104 may be configured to receive input from a user that corresponds to a request to preview one or more video compilations. The input component 130 may be configured to generate a request to preview a given video compilation based on the received input.

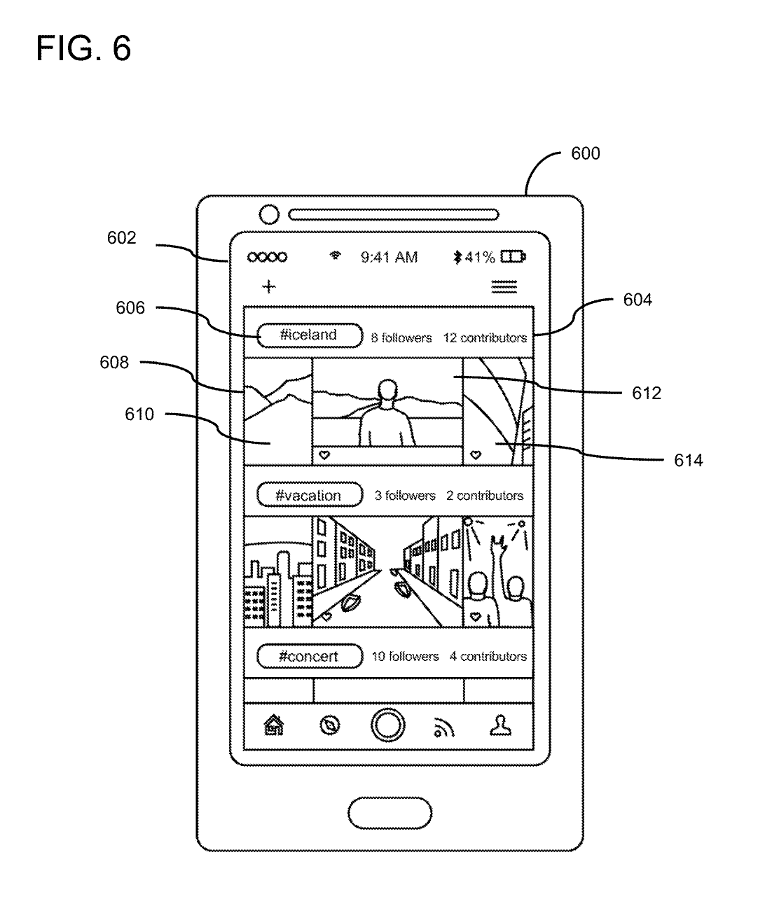

By way of non-limiting illustration in FIG. 6, yet another exemplary user interface 604 displayed on a display screen 602 of a user device 600 is shown. In an implementation, the display screen 602 may be a touch-sensitive display screen and/or other display screen. The display screen 602 may be configured to receive user input via physical touching, pressing, tapping, swiping, and other input via the display screen 602. The user interface 604 may comprise an exemplary user interface configured to receive user input to generate requests to preview a video compilation, and/or other requests.

In an implementation, the user interface 604 may include one or more of a first input field 606 and/or other input fields, a first preview area 608 and/or other preview areas, and/or other components. The first input field 606 may be configured to receive user entry and/or selection of information relating to searching for one or more video compilations to preview (e.g., keywords or other input indicating search criteria). Based on user-provided information (e.g., one or more hashtags and/or other information), the user device 600 may communicate a request to preview a video compilation satisfying the user-provided information.

Returning to FIG. 1, in an implementation, based on a selected subset of frames for a given preview by the search component 112, the playback component 118 may be configured to provide the given preview to a requesting user device. A preview may be provided, for example, by communicating information corresponding to the subset of frames to a user device. The subset of frames may be presented by a user device in a timeline style, video trailer style, and/or other preview style.

In an implementation, the presentation component 132 of user device 104 may be configured to receive information communicated to the user device 104 from server 102 (e.g., playback component 118 and/or other components). For example, the presentation component 132 may be configured to receive information corresponding to a preview of a video compilation and/or other information. The presentation component 132 may be configured to effectuate presentation of a given preview based on information received from the server 102 and/or other information.

By way of non-limiting illustration in FIG. 6, the user device 600 may be configured to receive a preview of a video compilation (e.g., that matches search criteria provided by a user in the first input filed 606). The preview may be presented in the first preview area 608. The preview may include a select subset of frames of the video compilation. The preview may comprise a timeline preview of the select subset of frames displayed in temporal order of frames and/or other type of previews. For example, the preview may include a first frame 610, a second frame 612, a third frame 614, and/or other frames. For purposes of illustration only, the first frame 610 may comprise by the start of the preview, while the third frame 614 may comprise the end of the preview.

Returning to FIG. 1, in an implementation, the request component 110 may be configured to receive requests of users to playback one or more video compilations and/or other requests. Requests to playback a given video compilation may be received from user devices. Requests to playback a given video may be generated at user devices based on input by users at the user devices. By way of non-limiting example, users may provide input at a user device during presentation of a preview of a video compilation to start playback of the video compilation (e.g., as opposed to merely viewing the preview).

In an implementation, the playback component 118 may be configured to facilitate playback of video compilations at user devices. The playback component 118 may be configured such that facilitating playback of a given video compilation comprises one or more of: executing a video file of a video compilation at the server 102 and providing a video stream corresponding to executed video file to a user device; executing individual video files corresponding to individual videos of a video compilation and providing a succession of video streams corresponding to the individual videos to a user device; communicating an executable video file (or a copy) corresponding to a video compilation to a user device (e.g., for execution by the user device); communicating individual video files (or copies) corresponding to individual videos of a video compilation to a user device (e.g., for execution by the user device); communicating a network address of a video compilation to a user device to allow the user to obtain the video compilation from network storage; communicating individual network addresses of individual videos of a video compilation to a user device to allow the user device to obtain individual videos of the video compilation from network storage; and/or other techniques.

In an implementation, the presentation component 132 of user device 104 may be configured to receive information from server 102 (e.g., playback component 118) configured to effectuate playback of one or more video compilations at a user device. For example, the received information may include one or more of executable files which, when executed, effectuate playback at the user device; network addresses pointing to a video compilation and/or individual videos of a video compilation; and/or other information. The presentation component 132 may be configured to present a video compilation playback in a user interface, display window, and/or other display mechanism on a user device.

In an implementation, permission component 116 of server 102 may be configured to, upon generation of a video compilation by the compilation component 114, establish one or more permissions associated with the video compilation. The permission component 116 may be configured to assign one or more permissions of a video compilation to one or more users. The permission component 116 may be configured to transfer an assignment of one or more permissions to one or more users of the system 100.

In an implementation, permission may correspond to one or more of a user's ability to share a video compilation, view a video compilation, modify a video compilation and/or information associated with the video compilation, and/or other permissions. In an implementation, permissions may be assigned to single users, groups of users, publically, and/or other types of assignments.

In an implementation, the permission component 116 may be configured to assign permissions of a video compilation to a user requesting to generate the video compilation. In an implementation, a user may specify, before, after, or in a request, one or more other users with which assignment of one or more permissions of a video compilation should be transferred. For example, a first user may generate a request to generate a video compilation on behalf of second user. A subsequent generation of the video compilation may thereafter have permissions of the video compilation assigned directly to the second user and/or revoked from the first user and transferred to the second user. The specification of permission assignments may be provided by user input at a user device used to generate requests. By way of non-limiting example, the input component 130 of user device 104 may be configured to receive user input corresponding to an assignment and/or transfer of permission. The request for assignment and/or transfer of permission may be communicated along with a request to generate a video compilation, before the request, after the request, and/or at other times.

By way of non-limiting illustration in FIG. 5, the user interface 504 may include second interface element 510 corresponding to requesting permission assignment and/or transfer. Selection of the second interface element 510 may effectuate presentation of an additional user interface and/or user interface portion (e.g., a pop up window, drop down menu, and/or other components) that may allow a user of the user device 500 to specify users, permissions, and/or other information related to assignment and/or transfer of permissions.

By way of non-limiting example, in an implementation, a user may be a system administrator. The administrator may generate a video compilation on behalf of another user. The other user may be, for example, a celebrity, a user subscribed to a paid service, and/or other users.

Returning to FIG. 1, the request component 110 may be configured to receive requests of users to modify one or more videos and/or video compilations, and/or other requests. Modification may include one or more of editing individual videos and/or a video compilations, adding (e.g., contributing) videos to a video compilation, removing videos from a video compilation, adding information associated with a video and/or video compilation, removing information associated with a video and/or video compilation, and/or other modifications. A given user's ability to modify a video compilation may be based on one or more permissions associated with the user and/or video compilation. The requests may be generated at user devices based on input by users of the user devices. By way of non-limiting example, the input component 130 of user device 104 may be configured to receive input from a user of user device 104 relating to requests to modify a video compilation. For example, the user device 104 may present a user interface configured to enable a user to submit requests to add videos to a given video compilation and/or other requests for video compilation modifications.

In an implementation, the compilation component 114 may be configured to update a given video compilation based on requested modifications to the video compilation. In some implementations, adding a video to a video compilation may include one or more of appending the video to a video file representative of the video compilation in the network storage, storing the video in network storage and obtaining a network address of the video and associating it with the video compilation, and/or other techniques.

In an implementation, a video that may be added to a video compilation may comprise one or more of a video stored in network storage, a video stored on a user device, a video captured by a user device and streamed to the server 102 in real-time or near real-time, and/or other videos. In an implementation, responsive to receiving a request to add a video to a video compilation by the request component 110, the upload component 108 may be configured to receive a video stream corresponding to a real-time, or near real-time, capture of video a user device. The upload component 108 may receive at least part of a video (that is to be added to the video compilation) based on a received video stream. The compilation component 114 may be configured to update the video compilation based on the at least part of the video from the video stream. As additional parts of the “live” video are continuously captured and streamed via the upload component 108, the compilation component 114 may continuously update the video compilation to include the additional parts of the continuously captured and streamed video.

In an implementation, the video compilation may be updated by storing the at least part of the video received from the video stream in the network storage, associating the video compilation with the at least part of the video received from the video stream, etc. In an implementation, the video compilation may be associated with the at least part of the video by obtaining the video compilation from the network storage and appending the at least part of the video received from the video stream to the video compilation; identify a network address of the at least part of the video in the network storage and associating the video compilation with the network address; etc.

In an implementation, user input facilitating the generating of requests to add videos to a video compilation may include one or more of drag-and-drop input, one or more predefined gestures performed by the user on a touch-sensitive display of the user device 104, and/or other input. In an implementation, a user device may be currently presenting one or more of a video compilation and/or preview. A request to add one or more videos may be made during such presentation. By way of non-limiting example, during presentation of the video compilation and/or preview, one or more predefined user inputs and/or other inputs may cause a user device to generate a request to add one or more videos to the currently presented (or previewed) video compilation.

In an implementation, the input component 130 of user device 104 may be configured to receive user input relating to one or more requests to modify (e.g., add one or more videos and/or other modifications) a given video compilation. In an implementation, requests to modify a video compilation may be based on the presentation component 132 presenting one or more of a video compilation and/or preview of a video compilation. The input component 130 may be configured such that one or more predefined user inputs during presentation of the video compilation and/or preview may automatically generate a request to modify the video compilation. By way of non-limiting example, a predefined user input may include one or more of a selection of a component of a user interface, a given gesture input via a touch-sensitive display of the user device, a given voice input, and/or other input.

In an implementation, responsive to detecting one or more predefined user inputs at the end (or other part) of a video compilation and/or preview, a request to add one or more videos to the end (or other part) of the video compilation (and/or other modification requests) may be generated. By way of non-limiting example, when a user provides one or more predefined user inputs while an ending frame of a video compilation and/or preview is displayed on a user device, a request to add a video to the end of the video compilation may be generated. In some implementations, a given predefined input may include a swipe gesture on a touch-sensitive display of the user device, and/or other input.

In an implementation, responsive to detecting one or more predefined user inputs during presentation of other parts of a video compilation and/or preview, a request to add one or more videos at the currently viewed part of the video compilation and/or preview (e.g., instead of to the end of the video compilation) may be generated. By way of non-limiting example, when a user provides a predefined user input during presentation of a given frame of the video compilation and/or preview, a request to add a video to the video compilation after the currently viewed frame (and/or video associated with the currently viewed frame) may be generated.

In an implementation, responsive to detecting one or more predefined user inputs during presentation of a video compilation and/or preview, user device 104 may automatically launch an image capturing application of the user device 104. By way of non-limiting example, launching an image capturing application may include one or more of a turning on an imaging device (e.g., camera) of the user device 104, displaying a preview window of the images captured by the imaging device, starting a video record function, starting a streaming function (e.g., to stream the captured video to server 102) and/or other operations. The capture component 128 may be configured to communicate a video stream (comprising portions of the captured video) to the server 102 (e.g., upload component 108 and/or other components).

By way of non-limiting illustration in FIG. 6, the user device 600 may be configured to display a preview of a video compilation in the first preview area 608. For purposes of illustration only, the first frame 610 may comprise the start of the preview, while the third frame 614 may comprise the end of the preview. During presentation of the end of the preview (e.g., during presentation of the third frame 614), the user device 600 may generate a request to modify the currently previewed video compilation based on one or more predefined user inputs being detected. For example, during presentation of the third frame 614 of the preview, a user input corresponding to a swipe gesture on the display screen 602 of the user device 600 may cause the user device 600 to automatically generate a request to modify the currently previewed video compilation. The modification may include, for example, adding one or more videos to the video compilation and/or other modifications. In an implementation, the user device 600 may be configured to automatically launch an image capturing application. The user device 600 may be configured to communicate a video stream corresponding to a real-time or near real-time capture of a video to the server 102.

In an implementation, a user may provide input at the user device 104 to effectuate image capturing and/or other features and/or functions. By way of non-limiting example, user input may effectuate one or more of starting a recording of a video, pausing a recording, resuming a recording, and/or other features and/or functions. User input may include one or more of entry and/or selection of a portion of a touch-sensitive display screen and/or a physical interface element; a voice input; a gesture input; and/or other inputs. In some implementations, entry and/or selection of a portion of a touch-sensitive display screen may correspond to one or more of a tap, a tap-and-hold, a tap-and-release, release, a swipe, and/or other types of input to a touch-sensitive display screen. In some implementations, input to a touch-sensitive display screen may correspond to a portion of the display screen that may be configured to display a virtual input element. By way of non-limiting example, a virtual input element may be a displayed record button, pause button, resume button, and/or other elements. In some implementations, user input to a touch-sensitive display screen may be provided in other portions of the screen that may or may not display corresponding virtual input elements (e.g., portions that display the “live” image being captured by a viewfinder and does not display any virtual input elements).

By way of non-limiting example, a user may tap one or more portions of a touch-sensitive display screen of a user device to effectuate one or more of record, pause, resume, and/or other functions. The user device may, for example, detect the foregoing respective touch inputs, and perform the respective actions (e.g., start, pause, resume, etc.) corresponding to the touch inputs. In one use case, the action(s) performed by the user device may be based on the state of the recording. If, for instance, the recording has not started, tapping on any portion of the touch-sensitive display screen may cause the user device to start the recording of the video. If the recording of the video is in progress and is not paused, tapping on any portion of the touch-sensitive display screen may cause the user device to pause the recording of the video. If the recording of the video is paused, tapping on any portion of the touch-sensitive display screen may cause the user device to resume the recording of the video.

Other non-limiting examples include a user tapping-and-holding a portion of a touch-sensitive display screen of a user device to cause the user device to start and/or resume a recording of a video, the user releasing his/her hold on the portion of the touch-sensitive display screen to pause the recording of the video, or the user providing other inputs to impact the recording of the video.

Returning to FIG. 1, in an implementation, playback component 118 of server 102 may be configured such that playback of a video compilation at a given user device may comprise playback including one or more current modifications to the video compilation provided by another given user device. For example, playback of a given video compilation to a given user at a given user device may include real-time, or near real-time, playback of a video stream (corresponding to a currently added video) provided by another user of another user device (e.g., playback of the video complication including real-time playback of live captured video). By way of non-limiting example, a video stream corresponding to a video compilation may be provided to a given user requesting to playback the video compilation. The video stream may include playback of at least part of a currently added video determined based on a received second video stream corresponding to a real-time, or near real-time, capture of a video by another user of another user device, the other user being associated with a request to modify the video compilation.

In an implementation, at least part of a live captured video may be made available for viewing during playback of a video compilation before other parts of the video are received via a second video stream. For example, the other parts of the video may yet to be captured by a user device, however at least part of the video that has been captured and streamed may be immediately available for viewing in the video compilation. In an implementation, at least part of a captured video may be made available for viewing during playback of the video compilation once an entirety of the video is received via the second video stream and stored in network storage. In this manner, the entirety of the captured video may be available to a user upon viewing the video compilation.

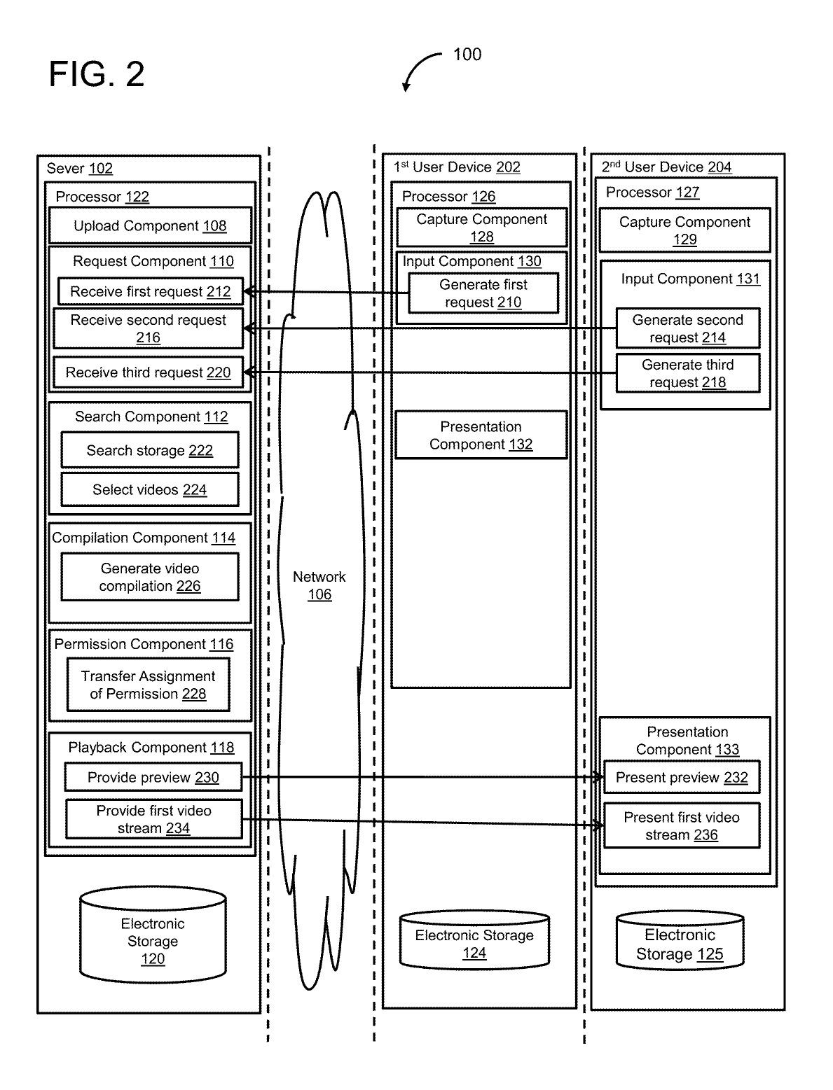

Referring now to FIG. 2, an exemplary flow diagram of information communication between the server 102, a first user device 202, and/or a second user device 204 of system 100 is shown. It is noted that the flow diagram is provided for illustrative purposes and is not to be considered limiting. For example, the flow of information shown in FIG. 2 is provided only as an illustrative example of one or more operations corresponding to distributing video compilation of user-captured videos. In an implementation, the flow of information may be accomplished with one or more additional operations not described and/or without one or more of the operations discussed. Additionally, the order in which information may be generated and/or communicated is not intended to be limiting.

The first user device 202 may include one or more physical processors 126. Processor 126 (and/or processors 126) may be programmed to execute machine-readable instructions. The machine-readable instructions may include one or more computer program components which, when executed, facilitate distributing video compilations of user-captured videos and/or other features or functions. The computer program components may include one or more of a capture component 128, an input component 130, a presentation component 132, and/or other components.

The second user device 204 may include one or more physical processors 127. Processor 127 (and/or processors 127) may be programmed to execute machine-readable instructions. The machine-readable instructions may include one or more computer program components which, when executed, facilitate distributing video compilations of user-captured videos and/or other features or functions. The computer program components may include one or more of a capture component 129, an input component 131, a presentation component 133 and/or other components. The computer program components of first user device 202 and/or second user device 204 may be the same or similar components as described herein in connection with user device 104 in FIG. 1.

In an implementation, the input component 130 of first user device 202 may be configured to generate (210) a first request to generate a video compilation. The first request may be generated based on input by a first user of the first user device 202. The first request may include one or more request criteria, one or more specifications of permission assignments, and/or other information. The first request (210) may be communicated to server 102 over communication network 106.

The request component 110 of server 102 may be configured to receive (212) the first request and/or other requests. The search component 112 may be configured to search (222) network storage and/or other video sources for a plurality of videos that may satisfy the one or more request criteria of the first request and/or other requests. The search component 112 may be configured to select (224) from the plurality of videos, at least some of the videos for the video compilation. The compilation component 114 may be configured to generate (226) the video compilation based on the at least some selected videos. The permission component 116 may be configured to transfer (228) assignment of one or more permissions associated with the video compilation to a second user.

In an implementation, the input component 131 of second user device 204 may be configured to generate (214) a second request to preview a video compilation and/or other requests. The second request may include a specification of a given video compilation for which a preview is requested, one or more request criteria suitable for generating a video compilation for which a preview may be provided, and/or other information. The second request may be communicated to server 102 over communication network 106.

The request component 110 of server 102 may be configured to receive (216) the second request. The presentation component 118 may be configured to provide (230) a preview and/or information corresponding to a preview of a video compilation associated with the second request to the second user device 204. For example, the playback component 118 and/or other components may be configured to select a subset of frames of the video compilation to include in the preview.

The presentation component 133 of second user device 204 may be configured to receive the preview and/or other information communicated from the server 102. The presentation component 133 may be configured to present 232 the preview on a display of the second user device 204.

In an implementation, the input component 131 of second user device 204 may be configured to generate (218) a third request to playback a video compilation and/or other requests. The request component 110 may be configured to receive (220) the third request. The playback component 118 may be configured to provide (234) a first video stream corresponding to the video compilation to the second user device 204. The presentation component 133 of second user device 204 may be configured to receive and/or present (236) the first video stream to facilitate playback of the video compilation.

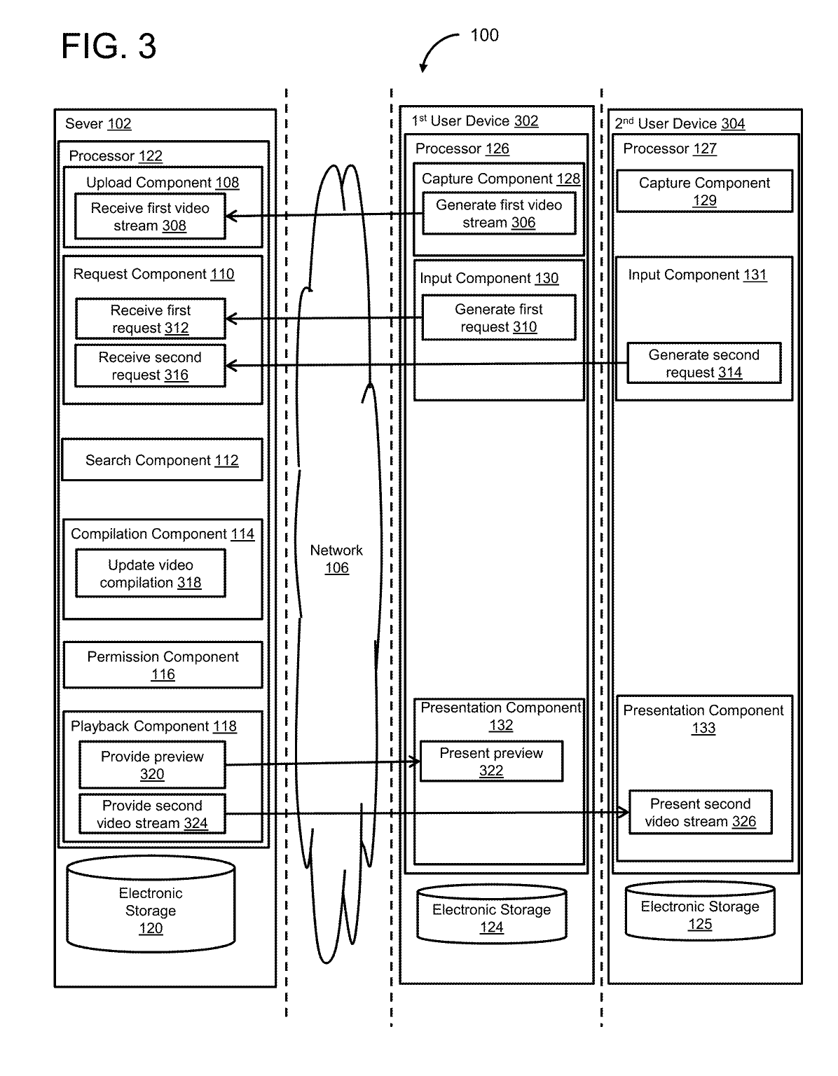

Referring now to FIG. 3, another exemplary flow diagram of information communication between the server 102, a first user device 302, and/or a second user device 304 of system 100 is shown. It is noted that the flow diagram is provided for illustrative purposes and is not to be considered limiting. For example the flow of information shown in FIG. 3 is provided only as an illustrative example of one or more operations corresponding to distributing video compilation of user-captured videos. In an implementation, the flow of information may be accomplished with one or more additional operations not described, and/or without one or more of the operations discussed. Additionally, the order in which information may be generated and/or communicated is not intended to be limiting.

The first user device 302 may include one or more physical processors 126. Processor 126 (and/or processors 126) may be programmed to execute machine-readable instructions. The machine-readable instructions may include one or more computer program components which, when executed, facilitate distributing video compilations of user-captured videos and/or other features or functions. The computer program components may include one or more of a capture component 128, an input component 130, a presentation component 132, and/or other components.

The second user device 304 may include one or more physical processors 127. Processor 127 (and/or processors 127) may be programmed to execute machine-readable instructions. The machine-readable instructions may include one or more computer program components which, when executed, facilitate distributing video compilations of user-captured videos and/or other features or functions. The computer program components may include one or more of a capture component 129, an input component 131, a presentation component 133 and/or other components. The computer program components of first user device 302 and/or second user device 304 may be the same or similar components as described herein in connection with user device 104 in FIG. 1.

In an implementation, the playback component 118 may be configured to provide 320 a preview of a video compilation to the first user device 302. The preview may comprise a subset of frames of the video compilation. In an implementation, the input component 130 of first user device 302 may be configured to generate 310 a first request to modify the video compilation. The modification may include adding one or more videos to the video compilation. The request component 110 may be configured to receive 312 the first request.

The capture component 128 of first user device 302 may be configured to generate 306 a first video stream. The first video stream may correspond to a live capture of a first video by the first user device 302. The upload component 108 may be configured to receive 308 the first video stream. The first video stream may include at least part of the first video. The compilation component 114 may be configured to update 318 the video compilation based on the received first video stream.

In an implementation, the input component 131 of second user device 304 may be configured to generate 314 a second request to playback a video compilation. The video compilation requested for playback may be the video compilation modified by the first user device 302. The playback component 118 may be configured to provide (324) a second video stream corresponding to the video compilation to the second user device 304. The second video stream may include the received at least part of the first video (from the first video stream received from the first user device 302 used to update the video compilation). The presentation component 133 of second user device 304 may be configured to receive and/or present 326 the second video stream on a display of the second user device 304.

Returning to FIG. 1, user device 104 (and/or other user devices portrayed in other figures) may comprise one or more of a type of mobile terminal, fixed terminal, and/or other devices. For example, user device 104 may comprise a desktop computer, a notebook computer, a netbook computer, a tablet computer, a smartphone, a navigation device, an electronic book device, a gaming device, and/or any other user devices. In an implementation, user device 104 may comprise the accessories and peripherals of these devices. User device 104 may also support one or more types of interface to the user (such as “wearable” circuitry, etc.).

Communication network 106 of system 100 may comprise one or more networks such as a data network, a wireless network, a telephony network, and/or other communication networks. A data network may comprise any local area network (LAN), metropolitan area network (MAN), wide area network (WAN), a public data network (e.g., the Internet), short range wireless network, and/or any other suitable packet-switched network. The wireless network may, for example, comprise a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium (e.g., worldwide interoperability for microwave access (WiMAX), Long Term Evolution (LTE) networks, code division multiple access (CDMA), wideband code division multiple access (WCDMA), wireless fidelity (WiFi), wireless LAN (WLAN), Bluetooth, Internet Protocol (IP) data casting, satellite, mobile ad-hoc network (MANET), etc.).

The external resource(s) 105 may include sources of information that are outside of system 100, external entities participating with system 100 (e.g., distributed data sources, and/or other considerations), and/or other resources. In an implementation, some or all of the functionality attributed herein to external resource(s) 105 may be provided by resources included in system 100.

In an implementation, server 102 may include an electronic storage 120, one or more processors 122, and/or other components. Server 102 may include communication lines, or ports to enable the exchange of information with communication network 106 and/or other computing platforms. Illustration of server 102 in FIG. 1 is not intended to be limiting. Server 102 may include a plurality of hardware, software, and/or firmware components operating together to provide the functionality attributed herein to server 102. For example, server 102 may be implemented by a cloud of computing platforms operating together as server 102.

Electronic storage 120 may comprise non-transitory storage media that electronically stores information. The electronic storage media of electronic storage 120 may include one or both of system storage that is provided integrally (i.e., substantially non-removable) with server 102 and/or removable storage that is removably connectable to server 102 via, for example, a port (e.g., a USB port, a firewire port, etc.) or a drive (e.g., a disk drive, etc.). Electronic storage 120 may include optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 120 may include one or more virtual storage resources (e.g., cloud storage, a virtual private network, and/or other virtual storage resources). Electronic storage 120 may store software algorithms, information determined by processor 122, information received from server 102, information received from user device 104, and/or other information that enables server 102 to function as described herein. In an implementation, electronic storage may comprise a non-transitory, tangible computer-readable storage medium with an executable program stored thereon, wherein the program instructs a microprocessor to perform some or all of the functionality of components 108, 110, 112, 114, 116, 118, and/or other components.

Processor 122 may be configured to provide information processing capabilities in server 102. As such, processor 122 may include a digital processor, an analog processor, a digital circuit designed to process information, an analog circuit designed to process information, a state machine, and/or other mechanisms for electronically processing information. Although processor 122 is shown in FIG. 1 as a single entity, this is for illustrative purposes only. In an implementation, processor 122 may include a plurality of processing units. These processing units may be physically located within the same device, or processor 122 may represent processing functionality of a plurality of devices operating in coordination. Processor 122 may be configured to execute components 108, 110, 112, 114, 116, 118, and/or other components. Processor 122 may be configured to execute components 108, 110, 112, 114, 116, 118, and/or other components by software; hardware; firmware; some combination of software, hardware, and/or firmware; and/or other mechanisms for configuring processing capabilities on processor 122.

It should be appreciated that although components 108, 110, 112, 114, 116, and 118 are illustrated in FIG. 1 as being co-located within a single processing unit, in implementations in which processor 122 includes multiple processing units, components 108, 110, 112, 114, 116, and/or 118 may be located remotely from the other components. The description of the functionality provided by the different components 108, 110, 112, 114, 116, and/or 118 described below is for illustrative purposes, and is not intended to be limiting, as any of components 108, 110, 112, 114, 116, and/or 118 may provide more or less functionality than described. For example, components 108, 110, 112, 114, 116, and/or 118 may be eliminated, and some or all of its functionality may be provided by other ones of components 108, 110, 112, 114, 116, and/or 118. As another example, processor 122 may be configured to execute one or more additional components that may perform some or all of the functionality attributed below to one of components 108, 110, 112, 114, 116, and/or 118.

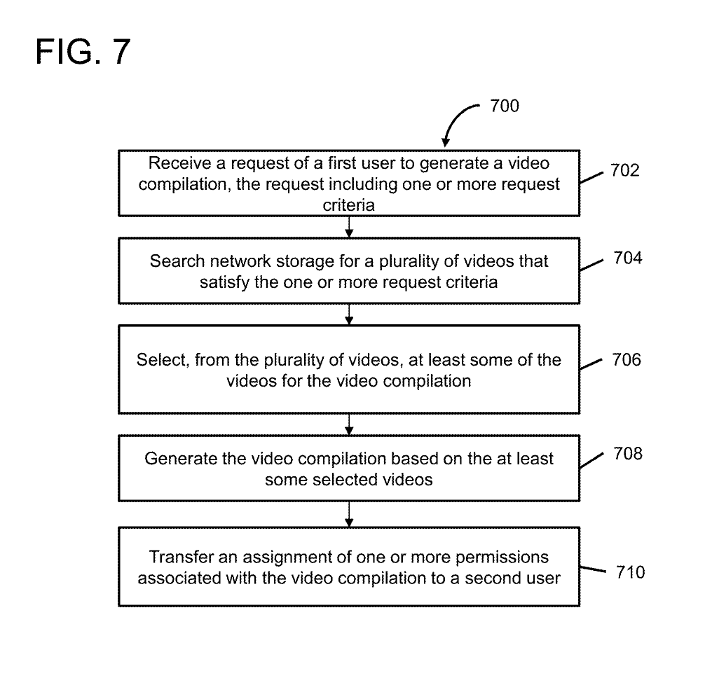

FIG. 7 illustrates a flowchart of a method of distributing a video compilation of user-captured videos, wherein users capture the videos via respective user devices and upload the user-captured videos to network storage, in accordance with one or more implementations. The operations of process 700 presented below are intended to be illustrative. In an implementation, process 700 may be accomplished with one or more additional operations not described and/or without one or more of the operations discussed. Additionally, the order in which the operations of process 700 are illustrated in FIG. 7 and described below is not intended to be limiting.

In certain implementations, one or more operations of process 700 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of process 700 in response to instructions stored electronically on an electronic storage medium. The one or more processing devices may include one or more devices configured through hardware, firmware, and/or software to be specifically designed for execution of one or more of the operations of process 700.

In an operation 702, a first request of a first user to generate a video compilation may be received. The request may include one or more request criteria for the video compilation. Operation 702 may be performed by one or more physical processors executing a request component that is the same as or similar to request component 110, in accordance with one or more implementations.

In an operation 704, network storage and/or other video sources may be searched for a plurality of videos that satisfy the one or more request criteria. The plurality of videos may have been captured and/or uploaded by a plurality of users. Operation 704 may be performed by one or more physical processors executing a search component that is the same as or similar to search component 112, in accordance with one or more implementations.

In an operation 706, at least some of the videos may be selected from the plurality of videos for the video compilation. Operation 706 may be performed by one or more physical processors executing a search component that is the same as or similar to search component 112, in accordance with one or more implementations.

In an operation 708, a video compilation may be generated based on the at least some selected videos and/or other information. Operation 708 may be performed by one or more physical processors executing a complication component that is the same as or similar to compilation component 114, in accordance with one or more implementations.

In an operation 710, an assignment of one or more permissions associated with the video compilation may be transferred to a second user. Operation 710 may be performed by one or more physical processors executing a permission component that is the same as or similar to permission component 116, in accordance with one or more implementations.

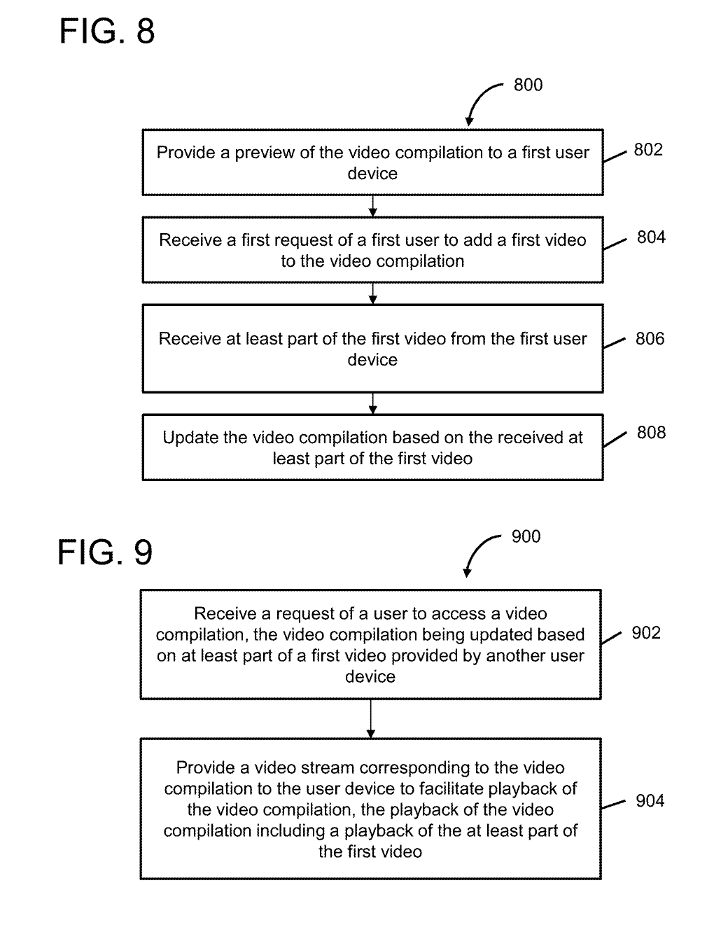

FIG. 8 illustrates a flowchart of a method of adding user-captured videos to a video compilation of user-captured videos, wherein users capture the videos via respective user devices and upload the user-captured videos to network storage, in accordance with one or more implementations. The operations of process 800 presented below are intended to be illustrative. In an implementation, process 800 may be accomplished with one or more additional operations not described and/or without one or more of the operations discussed. Additionally, the order in which the operations of process 800 are illustrated in FIG. 8 and described below is not intended to be limiting.

In certain implementations, one or more operations of process 800 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of process 800 in response to instructions stored electronically on an electronic storage medium. The one or more processing devices may include one or more devices configured through hardware, firmware, and/or software to be specifically designed for execution of one or more of the operations of process 800.

In an operation 802, a preview of a video compilation may be provided to a first user device. The preview may comprise a subset of frames of the video compilation. The preview may have a starting frame, an ending frame, and/or other frames. Operation 802 may be performed by one or more physical processors executing a playback component that is the same as or similar to playback component 118, in accordance with one or more implementations.

In an operation 804, a first request of a first user to add a first video to the video compilation may be received. The request may be generated at the first user device based on input by the first user at the first user device during presentation of the preview. For example the input may be provided during presentation of the ending frame of the preview. Operation 804 may be performed by one or more physical processors executing a request component that is the same as or similar to request component 110, in accordance with one or more implementations.

In an operation 806, at least part of the first video may be received from the first user device. By way of non-limiting example, the at least part of the first video may be received in real-time or near real-time as the first video is being captured by the first user device. Operation 806 may be performed by one or more physical processors executing an upload component that is the same as or similar to upload component 108, in accordance with one or more implementations.

In an operation 808, the video compilation may be updated based on the received at least part of the first video. By way of non-limiting example, the video compilation may be updated in real-time or near-real time as the at least part of the first video is received. In an implementation, a user viewing the video compilation on another user device may be able to view the received at least part of the first video. Operation 808 may be performed by one or more physical processors executing a complication component that is the same as or similar to compilation component 114, in accordance with one or more implementations.

FIG. 9 illustrates a flowchart of a method of presenting a video compilation of user-captured videos on a user device, wherein playback of the video compilation includes at least part of a video that is added to the video compilation in real-time or near real-time as it is captured at another user device, in accordance with one or more implementations. The operations of process 900 presented below are intended to be illustrative. In an implementation, process 900 may be accomplished with one or more additional operations not described and/or without one or more of the operations discussed. Additionally, the order in which the operations of process 900 are illustrated in FIG. 9 and described below is not intended to be limiting. In an implementation, one or more operations of process 900 may comprise operations performed following process 800 in FIG. 8.

In certain implementations, one or more operations of process 900 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of process 900 in response to instructions stored electronically on an electronic storage medium. The one or more processing devices may include one or more devices configured through hardware, firmware, and/or software to be specifically designed for execution of one or more of the operations of process 900.

In an operation 902, a request of a user to access a video compilation may be received. The video compilation may be updated in real-time or near real-time based on at least part of a first video provided by another user device. For example, the video compilation may be updated in accordance with operation 808 described in FIG. 8. Operation 902 may be performed by one or more physical processors executing a request component that is the same as or similar to request component 110, in accordance with one or more implementations.

In an operation 904 a video stream corresponding to the video compilation may be provided to the user device to facilitate playback of the video compilation. The playback of the video compilation may include the received at least part of the first video. Operation 904 may be performed by one or more physical processors executing a playback component that is the same as or similar to playback component 118, in accordance with one or more implementations.

Although the present invention has been described in detail for the purpose of illustration based on what is currently considered to be the most practical and preferred implementations, it is to be understood that such detail is solely for that purpose and that the invention is not limited to the disclosed implementations, but, on the contrary, is intended to cover modifications and equivalent arrangements that are within the spirit and scope of the appended claims. For example, it is to be understood that the present invention contemplates that, to the extent possible, one or more features of any implementation can be combined with one or more features of any other implementation.

1. A system for distributing a video compilation of user-captured videos, wherein users capture the videos via respective user devices and upload the user-captured videos to network storage, the system comprising:
one or more physical processors programmed to execute one or more computer program instructions which, when executed, cause the one or more physical processors to:
receive a first request from a first user on behalf of a second user to generate a video compilation, the first request including one or more request criteria for the video compilation;
search the network storage for a plurality of videos that satisfy the one or more request criteria, the plurality of videos being captured and uploaded by a plurality of users;
select, from the plurality of videos, at least some of the videos for the video compilation;
generate the video compilation based on the at least some selected videos; and
assigning one or more permissions associated with the video compilation to the second user without the one or more permissions ever being assigned to the first user.

2. The system of claim 1, wherein the one or more permissions correspond to editing the video compilation such that (i) no permission to edit the video compilation is assigned to the first user which prevents the first user from editing the video compilation (ii) but the second user has permission to edit the video subsequent to the assignment of the one or more permissions which enables the second user to edit the video compilation.

3. The system of claim 1, wherein the one or more permissions correspond to one or more of sharing the video compilation or editing the video compilation.

4. The system of claim 1, wherein the one or more request criteria corresponds to information associated with individual videos, the information including one or more of user-defined information, user information, temporal information, or geo-location information.

5. The system of claim 1, wherein the at least some selected videos include a first video and a second video, and wherein generating the video compilation comprises causing the one or more physical processors to:
obtain the first video and the second video from the network storage;
append the second video to the first video; and
wherein video compilation includes a combination of the first video and the second video such that playback of the video complication corresponds to seamless playback of the first video and the second video.

6. The system of claim 1, wherein the at least some selected videos include a first video and a second video, and wherein generating the video compilation comprises causing the one or more physical processors to:
identify a first network address of the first video in the network storage and a second network address of the second video in the network storage; and
associate the video compilation with the first network address and the second network address.

7. The system of claim 1, wherein the one or more physical processors are further caused to:
receive, from a first user device, a second request to access the video compilation; and
provide a preview of the video compilation to the first user device, the preview comprising a selected subset of frames of the video compilation, wherein individual frames in the subset of frames are selected from the video compilation at predetermined time-based intervals.

8. The system of claim 7, wherein providing the preview to the first user device comprises causing the one or more physical processor to:
determine the frames of the video compilation, the frames of the video compilation comprising frames of the at least some selected videos;
select the subset of frames based on the predetermined time-based intervals; and
provide the subset of frames to the first user device based on a temporal order of the frames included in the subset.

9. The system of claim 1, wherein the one or more physical processors are further caused to:
receive, from a first user device, a second request to play back the video compilation; and
provide a first video stream to the first user device, the first video stream corresponding to a playback of the video compilation including the at least some selected videos.

10. The system of claim 1, wherein the one or more physical processors are further caused to:
receive a first video stream corresponding to a live recording of a first video at a first user device; and
update the video compilation based on the first video stream.

11. A system for adding user-captured videos to a video compilation of user-captured videos, wherein users capture the videos via respective user devices and upload the user-captured videos to network storage, the system comprising:
one or more physical processors programmed to execute one or more computer program instructions which, when executed, cause the one or more physical processors to:
provide a preview of the video compilation to a first user device, the preview comprising a subset of frames of the video compilation, the preview having a starting frame and an ending frame;
detect a swipe gesture related to the ending frame being performed on a touch-sensitive display of the first user device during presentation of the preview, the swipe gesture causing generation of a first request to add a first video to the video compilation;
cause, at the first user device, capturing of a video stream responsive to the detection of the swipe gesture related to the ending frame and the generation of the first request such that the capturing of the video stream occurs at the first user device without any further user input subsequent to the swipe gesture;
receive at least part of the first video via the video stream being captured at the first user device; and
update the video compilation based on the received at least part of the first video.

12. The system of claim 11, wherein the one or more physical processors are caused to:
cause launching of an image capturing application at the first user device to perform the capturing of the video stream responsive to the detection of the swipe gesture related to the ending frame and the generation of the first request such that the image capturing application is launched without any further user input subsequent to the swipe gesture.

13. The system of claim 11, wherein the one or more physical processors are caused to:
continuously receive further parts of the first video as the video stream are being captured at the first user device; and
continuously update the video compilation based on the further parts of the first video as the further parts of the first video are being received.

14. The system of claim 13, wherein updating the video compilation based on the received at least part of the first video comprises causing the one or more physical processor to:
store the at least part of the first video received from the video stream in the network storage; and
associate the video compilation with the at least part of the first video received from the video stream.

15. The system of claim 14, wherein associating the video compilation with the at least part of the first video comprises causing the one or more physical processors to:
obtain the video compilation from the network storage; and
append the at least part of the first video received from the video stream to the video compilation.

16. The system of claim 14, wherein associating the video compilation with the at least part of the first video comprises causing the one or more physical processors to:
identify a first network address of the at least part of the first video in the network storage; and
associate the video compilation with the first network address.

17. The system of claim 11, wherein the one or more physical processors are further caused to:
receive a second request of a second user to access the video compilation, the second request received from a second user device associated with the second user; and
provide a video stream corresponding to the video compilation to the second user device, wherein providing the video stream facilitates playback of the video compilation at the second user device, the playback of the video compilation including a playback of the received at least part of the first video.

18. The system of claim 11, wherein providing the preview of the video compilation to the first user device comprises causing the one or more physical processors to:
determine the frames of the video compilation, the frames of the video compilation comprising frames of user-captured videos associated with the video compilation;
select the subset of frames based on predetermined time-based intervals, wherein individual frames in the subset of frames are selected from the video compilation at predetermined time-based intervals; and
provide the subset of frames to the first user device based on a temporal order of the frames included in the subset.

19. The system of claim 11, wherein individual user-captured videos are associated with one or more of user-defined information, location information, temporal information, or geo-location information.

20. The system of claim 11, wherein the one or more physical processors are further caused to:
receive a second request of the first user to generate a second video compilation, the second request including one or more request criteria for the second video compilation;
search electronic storage of the first user device for a plurality of videos that satisfy the one or more request criteria, the plurality of videos being stored in the electronic storage;
select, from the second plurality of videos, at least some of the second plurality of videos to present to the first user as suggestions for the second video compilation;
effectuate presentation of the at least some of the second plurality of videos on the first user device;
receive entry and/or selection of one or more of the at least some of the second plurality of videos; and
generate the video compilation based on the one or more of the at least some of the second plurality of videos.

21. The system of claim 11, wherein the swipe gesture is performed on a portion of the touch-sensitive display of the first user device that does not include a visual input element.

22. The system of claim 21, wherein the swipe gesture corresponds to one or more of starting a recording of the first video or resuming the recording of the first video.

23. The system of claim 22, wherein the at least part of the first video corresponds to a first part having an ending frame corresponding to a time of a tap input by the first user on the portion of the touch-sensitive display that does not display a visual input element, wherein the second tap input corresponds to pausing of the recording of the first video, and wherein the one or more physical processors are further caused to:
receive a second part of the first video from the first user device based on a subsequent tap input by the first user on the portion of the touch-sensitive display that does not display a visual input element, wherein the subsequent tap input corresponds to resuming of the recording of the first video; and
update the video compilation based on the received second part of the first video.

24. The system of claim 23, wherein the one or more physical processors are further caused to:
enable, prior to the video compilation being updated based on the received second part of the first video, access of the first part of the first video by one or more other users via the video compilation.

25. A method of distributing a video compilation of user-captured videos, wherein users capture the videos via respective user devices and upload the user-captured videos to network storage, the method being implemented by a computer system that includes one or more physical processors executing one or more computer program instructions which, when executed, perform the method, the method comprising
receiving, by the computer system, a first request from a first user on behalf of a second user to generate a video compilation, the first request including one or more request criteria for the video compilation;
searching, by the computer system, the network storage for a plurality of videos that satisfy the one or more request criteria, the plurality of videos being captured and uploaded by a plurality of users;
selecting, by the computer system, from the plurality of videos, at least some of the videos for the video compilation;
generating, by the computer system, the video compilation based on the at least some selected videos; and
assigning, by the computer system, one or more permissions associated with the video compilation to the second user without the one or more permissions ever being assigned to the first user.
